(19) United States
(12) Patent Application Publication
(10) Pub. No.: US 2026/0292741 A1
(43) Pub. Date: Sep. 24, 2026

(54) METHOD FOR DETERMINING TIMING ADVANCE, APPARATUS, AND STORAGE MEDIUM

(71) Applicant: BEIJING XIAOMI MOBILE SOFTWARE CO., LTD., Beijing (CN)

(72) Inventor: Xuhua TAO, Beijing (CN)

(21) Appl. No.: 19/478,201

(22) PCT Filed: Apr. 28, 2023
(86) PCT No.: PCT/CN2023/091874

§ 371 Date: Oct. 23, 2025

(51) Int. Cl. H04W 56/00; H04W 8/22; H04W 74/00; H04W 74/0833

(52) U.S. Cl. CPC H04W 56/0045; H04W 8/22; H04W 74/006; H04W 74/0833

(57) ABSTRACT

A method for determining a timing advance (TA), and includes: receiving a first message sent by a serving cell, where the first message is configured to indicate a duration of an aperiodic gap, and the duration of the aperiodic gap is a time for a terminal to determine the TA for a target cell.

### CROSS-REFERENCE TO RELATED APPLICATIONS

The present application is a U.S. National Stage of International Application No. PCT/CN2023/091874, filed on Apr. 28, 2023, the contents of all of which are incorporated herein by reference in their entirety for all purposes.

### BACKGROUND OF THE INVENTION

In a wireless communication system, cell handover is an important procedure in user equipment (UE) mobility management. After receiving a measurement report, a network device may select a neighboring cell with higher channel quality as a target cell and trigger a handover procedure of a UE from a serving cell to the target cell.

### SUMMARY OF THE INVENTION

The present disclosure relates to the technical field of communication, particularly a method for determining a timing advance, and a device.

A method for determining a timing advance, and a device are provided in embodiments of the present disclosure.

According to a first aspect of the embodiments of the present disclosure, a method for determining a timing advance is provided. The method is performed by a terminal and includes: receiving a first message sent by a serving cell, where the first message is configured to indicate a duration of an aperiodic gap, and the duration of the aperiodic gap is a time for the terminal to determine the timing advance (TA) for a target cell.

According to a second aspect of the embodiments of the present disclosure, a method for determining a timing advance is provided. The method is performed by a network device and includes: sending a first message to a terminal, where the first message is configured to indicate a duration of an aperiodic gap, and the duration of the aperiodic gap is a time for the terminal to determine the timing advance (TA) for a target cell.

According to a third aspect of embodiments of the present disclosure, a communication device is provided and includes: one or more processors; a memory configured to store processor-executable instructions, where the processor-executable instructions, when collectively executed by the one or more processors, cause the communication device to receive a first message sent by a serving cell, where the first message is configured to indicate a duration of an aperiodic gap, and the duration of the aperiodic gap is a time for the terminal to determine a timing advance (TA) for a target cell.

According to a fourth aspect of the embodiments of the present disclosure, a communication device is provided and includes: one or more processors; a memory configured to store processor-executable instructions, where the processor-executable instructions, when collectively executed by the one or more processors, cause the communication device to perform the method for determining the timing advance provided in the second aspect of the present disclosure.

It should be understood that the above general description and the following detailed description are only examples and explanations, and cannot limit the present disclosure.

### BRIEF DESCRIPTION OF DRAWINGS

The drawings here are incorporated into and constitute part of the specification, illustrating embodiments conforming to the present disclosure. They are combined with the specification to interpret the principles of the present disclosure.

FIG. 1 is a schematic diagram of a communication system according to an example.

FIG. 2 is a flowchart of a method for determining a timing advance according to an example.

FIG. 3 is a flowchart of a method for determining a timing advance according to an example.

FIG. 4 is a flowchart of a method for determining a timing advance according to an example.

FIG. 5 is a flowchart of a method for determining a timing advance according to an example.

FIG. 6 is a flowchart of a method for determining a timing advance according to an example.

FIG. 7 is a flowchart of a method for determining a timing advance according to an example.

FIG. 8 is a flowchart of a method for determining a timing advance according to an example.

FIG. 9 is a flowchart of a method for determining a timing advance according to an example.

FIG. 10 is a block diagram of a terminal according to an example.

FIG. 11 is a block diagram of a terminal according to an example.

FIG. 12 is a block diagram of a terminal according to an example.

FIG. 13 is a block diagram of a network device according to an example.

FIG. 14 is a block diagram of a communication device according to an example.

### DETAILED DESCRIPTION OF THE INVENTION

Examples will be described in detail here, with their examples shown in accompanying drawings. When the following description relates to the drawings, the same numbers in the different accompanying drawings represent the same or similar elements unless otherwise indicated. The embodiments described in the following examples do not represent all embodiments consistent with the present disclosure. Instead, they are merely examples of devices and methods consistent with some aspects of the present disclosure as detailed in the appended claims.

In the description of the embodiments of the present disclosure, the terms such as “first,” “second,” and the like are used to distinguish similar objects. They are not necessarily to be construed as a specific order or sequence. In addition, unless otherwise stated, in the description with reference to the drawings, the same reference numerals in different drawings represent the same elements.

In the description of the embodiments of the present disclosure, unless otherwise specified, “a plurality of” means two or more, and other quantifiers are similar to it. “At least one,” “one or more,” or similar expressions refer to any combination of those items, including any combination of single or plural items. For example, at least one may represent any number. For another example, one or more of a, b, and c may mean: a, b, c, a-b, a-c, b-c, or a-b-c, where a, b, c may be singular or plural. “And/or” is an association relationship describing associated objects and indicates that three relationships may exist, e.g., A and/or B may indicate that A exists alone, A and B exist at the same time, and B exists alone, where A and B may be singular or plural. The character “” indicates that front and back associated objects have an ‘OR’ relationship. The singular forms “one,” “a,” “an,” “the,” “said,” “aforementioned,” and “foregoing” are intended to include the plural forms as well, unless the context clearly indicates otherwise.

In the description of the embodiments of the present disclosure, descriptions such as “A in one situation, B in another situation” and “A in response to one situation, B in response to another situation” may include the following technical solutions according to the situation: A is performed independently of B, that is, A in some embodiments; B is performed independently of A, i.e., B in some embodiments; A and B are selectively performed, i.e., A and B are selected to be performed in some embodiments; and both A and B are performed, i.e., A and B in some embodiments. It is similar to the above when there are more branches, such as A, B, and C.

In the description of the embodiments of the present disclosure, “including A,” “comprising A,” “being used to indicate A,” and “carrying A” may be interpreted as directly carrying A, and may also be interpreted as indirectly indicating A.

In the description of the embodiments of the present disclosure, the terms such as “in a case where,” “in response to determining,” “in the case of,” “at the time of,” “when,” “if,” and “in the event of” may be interchanged.

In some embodiments, the terms such as “greater than,” “greater than or equal to,” “above,” “higher than,” and “not less than” may be interchanged, and the terms such as “less than,” “less than or equal to,” “below,” “lower than,” and “not greater than” may be interchanged.

In some embodiments, the terms such as “network element,” “node,” “function,” “apparatus,” “device,” “system,” “chip,” and “system-on-chip” may be interchanged.

In addition, each element, each row, or each column in the tables of the embodiments of the present disclosure may be implemented as an independent embodiment, and a combination of any element, row, and column may also be implemented as an independent embodiment.

Although operations or steps are described in a particular order in the embodiments of the present disclosure or the drawings, they should not be understood as requiring that these operations or steps be performed in the particular order shown or in a sequential order, or requiring that all illustrated operations or steps be performed to achieve the desired results. In the embodiments of the present disclosure, these operations or steps may be performed in any order without contradiction; these operations or steps may also be performed in parallel; some of these operations or steps may also be performed; and operations or steps in the various embodiments or drawings may also be arbitrarily combined, which is not limited to the embodiments of the present disclosure.

It should be noted that the embodiments of the present disclosure are not exhaustive, are only an illustration of some embodiments, and are not intended to be a specific limitation on the protection scope of the present disclosure. Without contradiction, each step in a certain embodiment may be implemented as an independent embodiment. The steps may be arbitrarily combined; for example, a solution in which some steps are removed in a certain embodiment may also be implemented as an independent embodiment, and the order of each step may be arbitrarily exchanged in a certain embodiment. In addition, optional implementations in a certain embodiment may be arbitrarily combined. Furthermore, the embodiments may be arbitrarily combined; for example, some or all of the steps of different embodiments may be combined arbitrarily, and a certain embodiment may be combined arbitrarily with optional implementations of other embodiments.

In a wireless communication system, cell handover is an important procedure in user equipment (UE) mobility management. After receiving a measurement report, a network device may select a neighboring cell with higher channel quality as a target cell and trigger a handover procedure of a UE from a serving cell to the target cell. To shorten a handover delay, the UE may obtain a timing advance (TA) for the target cell before receiving a handover command sent by the network device.

An implementation environment for the embodiments of the present disclosure is first introduced below.

The technical solutions in the embodiments of the present disclosure may be applied to various communication systems. The communication system may include one or more of the 4th generation (4G) communication system, the 5th generation (5G) communication system, and other future wireless communication systems (such as 6G). The communication system may also include one or more of a public land mobile network (PLMN), a device-to-device (D2D) communication system, a machine-to-machine (M2M) communication system, an Internet of Things (IoT) communication system, a vehicle-to-everything (V2X) communication system, or other communication systems.

FIG. 1 is a schematic diagram of a communication system 100 according to an example. As shown in FIG. 1, the communication system 100 may include a terminal 150 and a network device 160. The communication system can be used to support 4G network access technologies, such as a long-term evolution (LTE) access technology, or 5G network access technologies, such as a new radio access technology (New RAT), or other future wireless communication technologies. It should be noted that one or more network devices and terminals may be provided in the communication system, and the number of network devices and terminals in the communication system shown in FIG. 1 is only an adaptive example, which is not limited to the present disclosure.

The network device in FIG. 1 may be used to provide the wireless communication function for the terminal. For example, the network device may include an evolutional Node B (eNB or eNodeB) in LTE; the network device may also include the next generation Node B (gNB or gNodeB) in a 5G network; the network device may also include an NG-radio access network (NG-RAN) device in a 5G network; the network device may also include at least one of a base station in a future evolved public land mobile network (PLMN), a broadband network gateway (BNG), an aggregation switch, or a non-3rd generation partnership project (3GPP) access device. In some examples, the network device in the embodiments of the present disclosure may include at least one of the following various forms of base stations, for example, macro base stations, micro base stations (also referred to as small stations), relay stations, access points, 5G base stations or future base stations, satellites, transmitting and receiving points (TRPs), transmitting points (TPs), mobile switching centers (MSCs), device-to-device (D2D), machine-to-machine (M2M), Internet of Things (IoT), vehicle-to-everything (V2X) or other devices that assume base station functions in the communication system, etc., which is not particularly limited to the embodiments of the present disclosure. For convenience of description, in the embodiments of the present disclosure, a device that provides a wireless communication function for the terminal may be referred to as the network device.

In some embodiments, the network device described above may include a core network device and an access network device, and the access network device may also be referred to as a base station.

The terminal in FIG. 1 may be an electronic device providing voice or data connectivity, for example, the terminal may also be referred to as a user equipment (UE), a subscriber unit, a mobile station, a station, a terminal, or the like. For example, the terminal may include a smartphone, a smart wearable device, a smart speaker, a smart tablet, a wireless modem, a wireless local loop (WLL) station, a personal digital assistant (PDA), a customer premise equipment (CPE), and the like. With the development of the wireless communication technology, devices that can access the communication system, communicate with the network device of the communication system, and communicate with other objects via the communication system, or devices that can perform direct communication between two or more devices may all be terminals in the embodiments of the present disclosure, for example, terminals and vehicles in intelligent transportation, household devices in smart homes, power meter reading instruments in smart grids, voltage monitoring instruments, environmental monitoring instruments, video monitoring instruments in intelligent security networks, cash registers, etc. In the embodiments of the present disclosure, the terminal may communicate with the network device. Communication may also be performed between a plurality of terminals. The terminal may be statically fixed or mobile, which is not limited to the embodiments of the present disclosure.

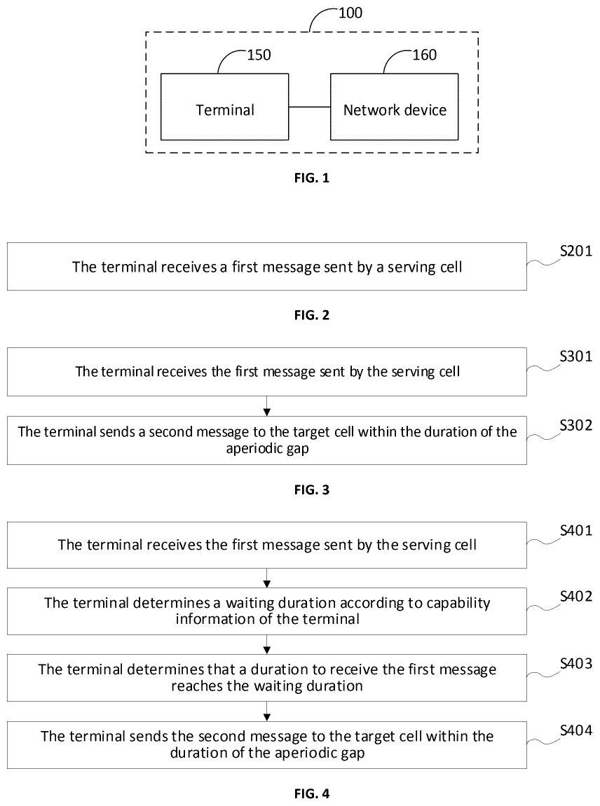

FIG. 2 is a flowchart of a method for determining a timing advance according to an example. The method may be performed by the terminal in the communication system described above. As shown in FIG. 2, the method may include S201.

In S201, the terminal receives a first message sent by a serving cell.

The first message may be configured to indicate a duration of an aperiodic gap, and the duration of the aperiodic gap may be a time for the terminal to determine a timing advance (TA) for a target cell.

The terminal receives the first message sent by the serving cell, where the first message is configured to indicate the duration of the aperiodic gap, and the duration of the aperiodic gap is the time for the terminal to determine the TA for the target cell. In this way, the terminal can determine the TA for the target cell within the duration of the aperiodic gap, and does not interfere with normal service of the serving cell during the process of determining the TA for the target cell. Therefore, the service interruption of the serving cell is reduced, and the network performance of the serving cell is improved.

In some embodiments, the aperiodic gap may also be an aperiodic slot, which is not limited to the embodiments of the present disclosure.

In some embodiments, the first message may be downlink control information (DCI).

In some embodiments, the first message may be sent to the terminal after the serving cell determines that the terminal has completed a layer 1 (L1) mobility measurement or a layer 2 (L2) mobility measurement for the target cell. The terminal may determine the TA for the target cell within the duration of the aperiodic gap indicated by the first message after receiving the first message.

With the above method, the terminal can determine the TA for the target cell within the duration of the aperiodic gap, and does not interfere with normal service of the serving cell during the process of determining the TA for the target cell. Therefore, the service interruption of the serving cell is reduced, and the network performance of the serving cell is improved.

In some embodiments, the terminal may receive the first message sent by the serving cell, and the first message is configured to indicate the duration of the aperiodic gap.

It should be noted that the terminal may determine the TA for the target cell within the duration of the aperiodic gap, or may perform other specified operations within the duration of the aperiodic gap, which is not limited to the embodiments of the present disclosure.

In some embodiments, the aperiodic gap may also be the aperiodic slot, which is not limited to the embodiments of the present disclosure.

FIG. 3 is a flowchart of a method for determining the timing advance according to an example. The method may be performed by the terminal in the communication system described above. As shown in FIG. 3, the method may include S301 and S302.

In S301, the terminal receives the first message sent by the serving cell.

The first message may be configured to indicate the duration of the aperiodic gap, and the duration of the aperiodic gap may be the time for the terminal to determine the timing advance (TA) for the target cell.

In some embodiments, the aperiodic gap may also be the aperiodic slot, which is not limited to the embodiments of the present disclosure. In some embodiments, the first message may be the DCI.

In S302, the terminal sends a second message to the target cell within the duration of the aperiodic gap.

The second message may be configured to determine the TA for the target cell, and there is no service transmission between the terminal and the serving cell within the duration of the aperiodic gap.

For example, within the duration of the aperiodic gap, the terminal may not send a physical uplink control channel (PUCCH), a physical uplink shared channel (PUSCH), and a synchronization reference signal (SRS) to the serving cell, or the terminal may not receive a physical downlink control channel (PDCCH), a physical downlink shared channel (PDSCH), a timing reference signal (TRS), a channel state information-reference signal (CSI-RS) sent by the serving cell for a channel quality indicator (CQI).

It should be noted that the above-described PUCCH, PUSCH, SRS, PDCCH, PDSCH, TRS, and CSI-RS are examples in which service transmission is not performed between the terminal and the serving cell, which is not limited to the embodiments of the present disclosure.

In some embodiments, the second message may be a physical downlink control channel order-based random access channel (PDCCH-ORD RACH) request.

In some embodiments, the terminal may activate the aperiodic gap after receiving the first message sent by the serving cell, send the second message to the target cell, and determine the TA for the target cell within the duration of the aperiodic gap.

In an implementation, the terminal may send the second message to the target cell after receiving the first message sent by the serving cell. After receiving the second message, the target cell decodes the second message and returns response information to the terminal. The terminal may determine the TA for the target cell based on the response information.

In some embodiments, the duration of the aperiodic gap may be determined according to a first duration and a second duration in a case where the second message is not configured with a time of a random access response (RAR) window. The first duration may be a duration of a time period configured for the terminal to send a preamble of the second message, and the second duration may be a radio frequency (RF) adjustment duration used by the terminal to switch an operating frequency point.

For example, a sum of the first duration and the second duration may be determined as the duration of the aperiodic gap.

It should be noted that the first duration and the second duration may be preset, and reference may be made to the descriptions in the 3GPP protocol, which is not repeated in the present disclosure.

In other embodiments, the duration of the aperiodic gap may be determined according to the first duration, the second duration, and a third duration in a case where the second message is configured with the time of the RAR window. The first duration may be the duration of the time period configured for the terminal to send the preamble of the second message, the second duration may be the RF adjustment duration used by the terminal to switch the operating frequency point, and the third duration may be the time of the RAR window for the target cell.

For example, it is necessary to switch the operating frequency point of the terminal from the serving cell to the target cell in a case where the terminal sends the second message to the target cell, and a duration of a time period during which the terminal switches the operating frequency point is the second duration.

In one implementation, a sum of the first duration, the second duration, and the third duration may be determined as the duration of the aperiodic gap.

In other embodiments, a first specified duration may be determined as the duration of the aperiodic gap in a case where the second message is not configured with the time of the RAR window. A second specified duration may be determined as the duration of the aperiodic gap in a case where the second message is configured with the time of the RAR window.

In one implementation, the first specified duration and the second specified duration may be preset, for example, the first specified duration may be 2 ms, 3 ms, or 5 ms, and the second specified duration may be 10 ms or 20 ms.

It should be noted that the first specified duration and the second specified duration described above are illustrative and are not limited to the embodiments of the present disclosure.

It should be noted that without contradiction, this embodiment can be mutually combined with the foregoing embodiments or implementations of the present disclosure and various optional solutions, and the specific implementation manners of the above steps in this embodiment can also refer to the descriptions in the foregoing embodiments of the present disclosure, which are not repeated here.

In this way, the terminal may activate the aperiodic gap after receiving the first message sent by the serving cell, send the second message to the target cell within the duration of the aperiodic gap, and determine the TA for the target cell. In this way, the terminal does not interfere with normal service of the serving cell during the process of determining the TA for the target cell. Therefore, the service interruption of the serving cell is reduced, and the network performance of the serving cell is improved.

FIG. 4 is a flowchart of a method for determining the timing advance according to an example. The method may be performed by the terminal in the communication system described above. As shown in FIG. 4, the method may include S401 to S404.

In S401, the terminal receives the first message sent by the serving cell.

The first message may be configured to indicate the duration of the aperiodic gap, and the duration of the aperiodic gap may be the time for the terminal to determine the TA for the target cell.

In some embodiments, the aperiodic gap may also be the aperiodic slot, which is not limited to the embodiments of the present disclosure.

In some embodiments, the first message may be the DCI.

In S402, the terminal determines a waiting duration according to capability information of the terminal.

In some embodiments, the capability information may indicate a frequency band range currently used by the terminal, and the frequency band range may include a low frequency band range and a high frequency band range.

For example, the low frequency band range may be a frequency range 1 (FR1) in the 3GPP protocol, and the high frequency band range may be a frequency range 2 (FR 2) in the 3GPP protocol.

In some embodiments, the terminal determines that the capability information of the terminal indicates the low frequency band range, and determines that the waiting duration is a first specified duration.

For example, it may be determined that the waiting duration is a first waiting duration in a case where the terminal determines that a supported frequency band range is the FR1.

In other embodiments, the terminal determines that the capability information of the terminal indicates the high frequency band range, and determines that the waiting duration is a second specified duration.

For example, it may be determined that the waiting duration is a second waiting duration in a case where the terminal determines that the supported frequency band range is the FR2.

It should be noted that the first specified duration and the second specified duration may be preset, and the second specified duration may be smaller than the first specified duration. For example, the first specified duration may be 0.5 ms, and the second specified duration may be 0.25 ms.

In S403, the terminal determines that a duration to receive the first message reaches the waiting duration.

In some embodiments, the terminal may start timing after receiving the first message sent by the serving cell and determine whether a timing duration reaches the waiting duration.

In S404, the terminal sends the second message to the target cell within the duration of the aperiodic gap.

The second message may be configured to determine the TA for the target cell, and there is no service transmission between the terminal and the serving cell within the duration of the aperiodic gap.

For example, within the duration of the aperiodic gap, the terminal may not send the PUCCH, the PUSCH, and the SRS to the serving cell, and the terminal may not receive the PDCCH, the PDSCH, the TRS, and the CSI-RS sent by the serving cell for the CQI.

It should be noted that the above-described PUCCH, PUSCH, SRS, PDCCH, PDSCH, TRS, and CSI-RS are examples in which the service transmission is not performed between the terminal and the serving cell, which is not limited to the embodiments of the present disclosure.

In some embodiments, the second message may be the PDCCH-ORD RACH request.

In some embodiments, the terminal may send the second message to the target cell in a case where the terminal determines that the duration to receive the first message reaches the waiting duration. After receiving the second message, the target cell may send the response information to the terminal based on the second message. The terminal may determine the TA for the target cell based on the response information.

For example, the terminal may send the second message to the target cell when the duration to receive the first message reaches 0.5 ms in a case where the waiting duration is 0.5 ms.

It should be noted that without contradiction, this embodiment can be mutually combined with the foregoing embodiments or implementations of the present disclosure and various optional solutions, and the specific implementation manners of the above steps in this embodiment can also refer to the descriptions in the foregoing embodiments of the present disclosure, which are not repeated here.

With the above method, the terminal can determine the waiting duration according to the capability information, and activate the aperiodic gap according to the waiting duration. In this way, the terminal can flexibly adjust the time to activate the aperiodic gap based on a frequency band range that the terminal can support.

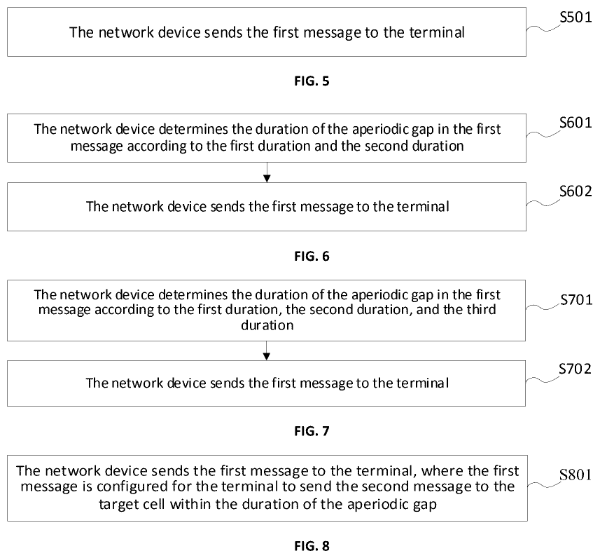

FIG. 5 is a flowchart of a method for determining the timing advance according to an example. The method may be performed by the network device in the communication system described above. As shown in FIG. 5, the method may include S501.

In S501, the network device sends the first message to the terminal.

The first message is configured to indicate the duration of the aperiodic gap, and the duration of the aperiodic gap may be the time for the terminal to determine the TA for the target cell.

In some embodiments, the aperiodic gap may also be the aperiodic slot, which is not limited to the embodiments of the present disclosure.

In some embodiments, the first message may be the DCI.

In some embodiments, the first message may be sent to the terminal after the network device determines that the terminal has completed the L1 mobility measurement or the L2 mobility measurement for the target cell, and the terminal is triggered by the first message to determine the TA for the target cell within the duration of the aperiodic gap indicated by the first message.

With the above method, the network device can trigger the terminal to determine the TA for the target cell within the duration of the aperiodic gap, and the normal service of the serving cell is not interfered with by the terminal during the process of determining the TA for the target cell by the terminal. Therefore, the service interruption of the serving cell is reduced, and the network performance of the serving cell is improved.

In some embodiments, the network device may send the first message to the terminal, and the first message is configured to indicate the duration of the aperiodic gap.

It should be noted that the terminal may determine the TA for the target cell within the duration of the aperiodic gap, or may perform other specified operations within the duration of the aperiodic gap, which is not limited to the embodiments of the present disclosure.

In some embodiments, the aperiodic gap may also be the aperiodic slot, which is not limited to the embodiments of the present disclosure.

In some embodiments, the first message is configured for the terminal to send the second message to the target cell within the duration of the aperiodic gap, where the second message may be configured to determine the TA for the target cell, and there is no service transmission between the terminal and the serving cell within the duration of the aperiodic gap.

For example, within the duration of the aperiodic gap, the terminal may not send the PUCCH, the PUSCH, and the SRS to the serving cell, and the terminal may not receive the PDCCH, the PDSCH, the TRS, and the CSI-RS sent by the serving cell for the CQI.

It should be noted that the above-described PUCCH, PUSCH, SRS, PDCCH, PDSCH, TRS, and CSI-RS are examples in which the service transmission is not performed between the terminal and the serving cell, which is not limited to the embodiments of the present disclosure.

In some embodiments, the second message may be the PDCCH-ORD RACH request.

In some embodiments, the terminal may activate the aperiodic gap after the network device sends the first message to the terminal. The terminal may send the second message to the target cell, and determine the TA for the target cell within the duration of the aperiodic gap.

In one implementation, the terminal may send the second message to the target cell after the network device sends the first message to the terminal. After receiving the second message, the target cell decodes the second message and returns the response information to the terminal. The terminal may determine the TA for the target cell based on the response information.

FIG. 6 is a flowchart of a method for determining the timing advance according to an example. The method may be performed by the network device in the communication system described above. As shown in FIG. 6, the second message is not configured with the time of the RAR window, and the method may include S601 and S602.

In S601, the network device determines the duration of the aperiodic gap in the first message according to the first duration and the second duration.

The first duration may be the duration of the time period configured for the terminal to send the preamble of the second message, and the second duration may be the RF adjustment duration used by the terminal to switch the operating frequency point.

It should be noted that the first duration and the second duration may be preset, and reference may be made to the descriptions in the 3GPP protocol, which is not repeated in the present disclosure.

For example, the sum of the first duration and the second duration may be determined as the duration of the aperiodic gap.

In S602, the network device sends the first message to the terminal.

In some embodiments, the network device may send the first message including the duration of the aperiodic gap to the terminal after determining the duration of the aperiodic gap.

It should be noted that without contradiction, this embodiment can be mutually combined with the foregoing embodiments or implementations of the present disclosure and various optional solutions, and the specific implementation manners of the above steps in this embodiment can also refer to the descriptions in the foregoing embodiments of the present disclosure, which are not repeated here.

Thus, the network device may determine the duration of the aperiodic gap based on the duration of the time period configured for the terminal to send the preamble of the second message, and the RF adjustment duration used by the terminal to switch the operating frequency point.

FIG. 7 is a flowchart of a method for determining the timing advance according to an example. The method may be performed by the network device in the communication system described above. As shown in FIG. 7, the second message is configured with the time of the RAR window, and the method may include S701 and S702.

In S701, the network device determines the duration of the aperiodic gap in the first message according to the first duration, the second duration, and the third duration.

The first duration may be the duration of the time period configured for the terminal to send the preamble of the second message, the second duration may be the RF adjustment duration used by the terminal to switch the operating frequency point, and the third duration may be the time of the RAR window for the target cell.

In one implementation, the network device may determine the sum of the first duration, the second duration, and the third duration as the duration of the aperiodic gap.

In S702, the network device sends the first message to the terminal.

In some embodiments, the network device may send the first message including the duration of the aperiodic gap to the terminal after determining the duration of the aperiodic gap.

In this way, the network device may determine the duration of the aperiodic gap based on the duration of the time period configured for the terminal to send the preamble of the second message, the RF adjustment duration used by the terminal to switch the operating frequency point, and the time of the RAR window for the target cell.

In other embodiments, the network device may determine the first specified duration as the duration of the aperiodic gap in a case where the second message is not configured with the time of the RAR window; and the network device may determine the second specified duration as the duration of the aperiodic gap in a case where the second message is configured with the time of the RAR window.

In one implementation, the first specified duration and the second specified duration may be preset, for example, the first specified duration may be 2 ms, 3 ms, or 5 ms, and the second specified duration may be 10 ms or 20 ms.

It should be noted that the first specified duration and the second specified duration described above are an illustration, which is not limited to the embodiments of the present disclosure.

It should be noted that without contradiction, this embodiment can be mutually combined with the foregoing embodiments or implementations of the present disclosure and various optional solutions, and the specific implementation manners of the above steps in this embodiment can also refer to the descriptions in the foregoing embodiments of the present disclosure, which are not repeated here.

Thus, the network device may determine the duration of the aperiodic gap based on the first specified duration or the second specified duration.

FIG. 8 is a flowchart of a method for determining the timing advance according to an example. The method may be performed by the network device in the communication system described above. As shown in FIG. 8, the method may include S801.

In S801, the network device sends the first message to the terminal, where the first message is configured for the terminal to send the second message to the target cell within the duration of the aperiodic gap.

The first message is configured to indicate the duration of the aperiodic gap, and the duration of the aperiodic gap may be the time for the terminal to determine the TA for the target cell, and the second message is configured to determine the TA for the target cell.

In some embodiments, the aperiodic gap may also be the aperiodic slot, which is not limited to the embodiments of the present disclosure.

In some embodiments, the first message may be the DCI.

In some embodiments, there is no service transmission between the terminal and the serving cell within the duration of the aperiodic gap.

For example, within the duration of the aperiodic gap, the terminal may not send the PUCCH, the PUSCH, and the SRS to the serving cell, and the terminal may not receive the PDCCH, the PDSCH, the TRS, and the CSI-RS sent by the serving cell for the CQI.

It should be noted that the above-described PUCCH, PUSCH, SRS, PDCCH, PDSCH, TRS, and CSI-RS are examples in which service transmission is not performed between the terminal and the serving cell, which is not limited to the embodiments of the present disclosure.

In some embodiments, the second message may be the PDCCH-ORD RACH request.

In some embodiments, the terminal determines that the duration to receive the first message reaches the waiting duration, and the waiting duration is determined according to the capability information of the terminal. The terminal sends the second message to the target cell within the duration of the aperiodic gap.

In some embodiments, the capability information may indicate the frequency band range currently used by the terminal, and the frequency band range may include the low frequency band range and the high frequency band range.

For example, the low frequency band range may be the FR1 in the 3GPP protocol, and the high frequency band range may be the FR2 in the 3GPP protocol.

In an implementation, the terminal determines that the capability information of the terminal indicates the low frequency band range, and determines that the waiting duration is the first specified duration.

For example, it may be determined that the waiting duration is the first waiting duration in a case where the terminal determines that the supported frequency band range is the FR1.

In another implementation, the terminal determines that the capability information of the terminal indicates the high frequency band range, and determines that the waiting duration is the second specified duration.

For example, it may be determined that the waiting duration is the second waiting duration in a case where the terminal determines that the supported frequency band range is the FR2.

It should be noted that the first specified duration and the second specified duration may be preset, and the second specified duration may be smaller than the first specified duration. For example, the first specified duration may be 0.5 ms, and the second specified duration may be 0.25 ms.

For example, the terminal may start timing after receiving the first message sent by the serving cell and determine whether the timing duration reaches the waiting duration. The terminal may send the second message to the target cell in a case where the terminal determines that the duration to receive the first message reaches the waiting duration. After receiving the second message, the target cell sends the response information to the terminal based on the second message. The terminal may determine the TA for the target cell based on the response information. For example, the terminal may send the second message to the target cell when the duration to receive the first message reaches 0.5 ms in a case where the waiting duration is 0.5 ms.

It should be noted that without contradiction, this embodiment can be mutually combined with the foregoing embodiments or implementations of the present disclosure and various optional solutions, and the specific implementation manners of the above steps in this embodiment can also refer to the descriptions in the foregoing embodiments of the present disclosure, which are not repeated here.

With the above method, the terminal can determine the waiting duration according to the capability information after the network device sends the first message to the terminal, and activate the aperiodic gap according to the waiting duration. In this way, the terminal can flexibly adjust the time to activate the aperiodic gap based on the frequency band range that the terminal can support.

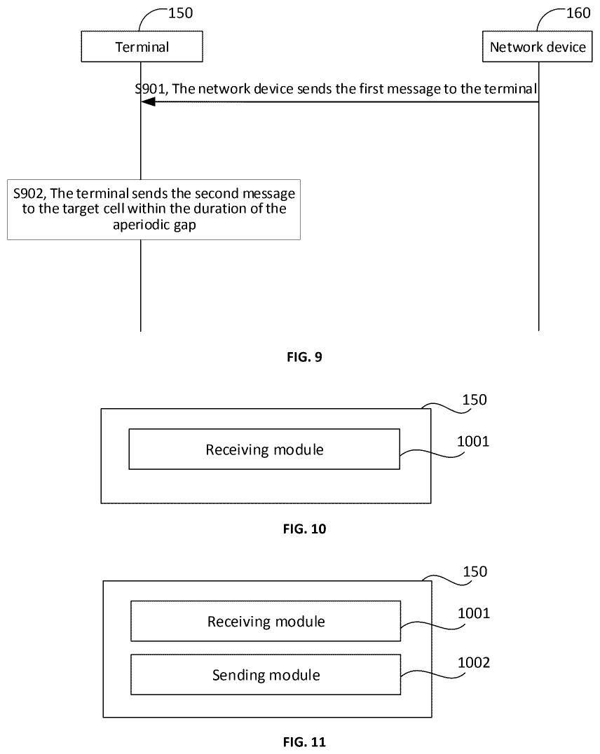

FIG. 9 is a flowchart of a method for determining the timing advance according to an example. As shown in FIG. 9, the method may include S901 and S902.

In S901, the network device sends the first message to the terminal.

The first message is configured to indicate the duration of the aperiodic gap, and the duration of the aperiodic gap may be the time for the terminal to determine the TA for the target cell.

In some embodiments, the aperiodic gap may also be the aperiodic slot, which is not limited to the embodiments of the present disclosure.

In some embodiments, the first message may be the DCI.

In some embodiments, the first message is configured for the terminal to send the second message to the target cell within the duration of the aperiodic gap, where the second message is configured to determine the TA for the target cell, and there is no service transmission between the terminal and the serving cell within the duration of the aperiodic gap.

In some embodiments, the second message is the PDCCH-ORD RACH.

In some embodiments, the second message is not configured with the time of the RAR window. The network device determines the duration of the aperiodic gap in the first message according to the first duration and the second duration, where the first duration may be the duration of the time period configured for the terminal to send the preamble of the second message, and the second duration may be the RF adjustment duration used by the terminal to switch the operating frequency point. The network device sends the first message to the terminal.

In other embodiments, the second message is configured with the time of the RAR window. The network device determines the duration of the aperiodic gap in the first message according to the first duration, the second duration, and the third duration, where the first duration may be the duration of the time period configured for the terminal to send the preamble of the second message, the second duration may be the RF adjustment duration used by the terminal to switch the operating frequency point, and the third duration is the time of the RAR window for the target cell. The network device sends the first message to the terminal.

In one implementation, the network device determines the sum of the first duration, the second duration, and the third duration as the duration of the aperiodic gap.

In S902, the terminal sends the second message to the target cell within the duration of the aperiodic gap.

The second message may be configured to determine the TA for the target cell, and there is no service transmission between the terminal and the serving cell within the duration of the aperiodic gap.

In some embodiments, the terminal determines the waiting duration according to the capability information of the terminal, determines that the duration to receive the first message reaches the waiting duration, and sends the second message to the target cell within the duration of the aperiodic gap.

In an implementation, the terminal may send the second message to the target cell after receiving the first message sent by the serving cell. After receiving the second message, the target cell decodes the second message and returns the response information to the terminal. The terminal may determine the TA for the target cell based on the response information.

In some embodiments, the capability information may indicate the frequency band range currently used by the terminal, and the frequency band range may include the low frequency band range and the high frequency band range.

In an implementation, it is determined that the capability information of the terminal indicates the low frequency band range; it is determined that the waiting duration is the first specified duration.

In another implementation, it is determined that the capability information of the terminal indicates the high frequency band range, and it is determined that the waiting duration is the second specified duration.

It should be noted that the first specified duration and the second specified duration may be preset, and the second specified duration may be smaller than the first specified duration. For example, the first specified duration may be 0.5 ms, and the second specified duration may be 0.25 ms.

It should be noted that without contradiction, this embodiment can be mutually combined with the foregoing embodiments or implementations of the present disclosure and various optional solutions, and the specific implementation manners of the above steps in this embodiment can also refer to the descriptions in the foregoing embodiments of the present disclosure, which are not repeated here.

With the above method, the terminal can determine the TA for the target cell within the duration of the aperiodic gap after the network device sends the first message to the terminal. The terminal does not interfere with the normal service of the serving cell during the process of determining the TA for the target cell. Therefore, the service interruption of the serving cell is reduced, and the network performance of the serving cell is improved.

In an example, the present disclosure further provides a communication system. The communication system may include the terminal and the network device, where the terminal may perform the method for determining the timing advance related to the terminal in the aforementioned embodiments of the present disclosure, and the network device may perform the method for determining the timing advance related to the network device in the aforementioned embodiments of the present disclosure.

FIG. 10 is a block diagram of a terminal 150 according to an example. As shown in FIG. 10, the terminal may include a receiving module 1001 configured to receive the first message sent by the serving cell, where the first message is configured to indicate the duration of the aperiodic gap, and the duration of the aperiodic gap is the time for the terminal to determine the timing advance (TA) for the target cell.

FIG. 11 is a block diagram of a terminal 150 according to an example. As shown in FIG. 11, the terminal may further include a sending module 1002.

The sending module 1002 is configured to send the second message to the target cell within the duration of the aperiodic gap, where the second message is configured to determine the TA for the target cell, and there is no service transmission between the terminal and the serving cell within the duration of the aperiodic gap.

In some embodiments, the second message is not configured with the time of the RAR window. The duration of the aperiodic gap is determined by: determining the duration of the aperiodic gap according to the first duration and the second duration, where the first duration is the duration of the time period configured for the terminal to send the preamble of the second message, and the second duration is the radio frequency (RF) adjustment duration used by the terminal to switch the operating frequency point.

In some embodiments, the second message is configured with the time of the RAR window. The duration of the aperiodic gap is determined by: determining the duration of the aperiodic gap according to the first duration, the second duration and the third duration, where the first duration is the duration of the time period configured for the terminal to send the preamble of the second message, the second duration is the RF adjustment duration used by the terminal to switch the operating frequency point, and the third duration is the time of the RAR window for the target cell.

In some embodiments, determining the duration of the aperiodic gap according to the first duration, the second duration, and the third duration includes: determining the sum of the first duration, the second duration, and the third duration as the duration of the aperiodic gap.

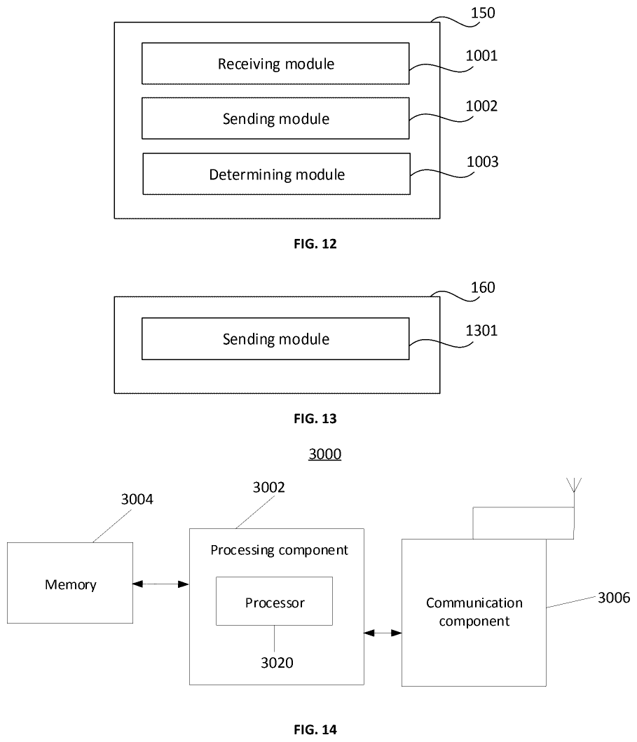

FIG. 12 is a block diagram of a terminal 150 according to an example. As shown in FIG. 12, the terminal may further include a determining module 1003.

The determining module 1003 is configured to determine the waiting duration according to the capability information of the terminal; and the sending module 1002 is further configured to determine that the duration to receive the first message reaches the waiting duration, and send the second message to the target cell within the duration of the aperiodic gap.

In some embodiments, the capability information indicates the frequency band range currently used by the terminal, and the frequency band range includes the low frequency band range and the high frequency band range.

In some embodiments, the determining module 1003 is further configured to determine that the capability information of the terminal indicates the low frequency band range, and determine that the waiting duration is the first specified duration.

In some embodiments, the determining module 1003 is further configured to determine that the capability information of the terminal indicates the high frequency band range, and determine that the waiting duration is the second specified duration.

In some embodiments, the second message is a random access channel (RACH) request based on a physical downlink control channel (PDCCH).

In some embodiments, the first message is the DCI.

FIG. 13 is a block diagram of a network device 160 according to an example. As shown in FIG. 13, the network device may include a sending module 1301.

The sending module 1301 is configured to send the first message to the terminal, where the first message is configured to indicate the duration of the aperiodic gap, and the duration of the aperiodic gap is the time for the terminal to determine the TA for the target cell.

In some embodiments, the first message is configured for the terminal to send the second message to the target cell within the duration of the aperiodic gap, where the second message is configured to determine the TA for the target cell, and there is no service transmission between the terminal and the serving cell within the duration of the aperiodic gap.

In some embodiments, the second message is not configured with the time of the RAR window. The sending module 1301 is further configured to determine the duration of the aperiodic gap in the first message according to the first duration and the second duration, where the first duration is the duration of the time period configured for the terminal to send the preamble of the second message, and the second duration is the RF adjustment duration used by the terminal to switch the operating frequency point; and send the first message to the terminal.

In some embodiments, the second message is configured with the time of the RAR window. The sending module 1301 is further configured to determine the duration of the aperiodic gap in the first message according to the first duration, the second duration and the third duration, where the first duration is the duration of the time period configured for the terminal to send the preamble of the second message, the second duration is the RF adjustment duration used by the terminal to switch the operating frequency point, and the third duration is the time of the RAR window for the target cell; and send the first message to the terminal.

In some embodiments, the sending module 1301 is further configured to determine the sum of the first duration, the second duration, and the third duration as the duration of the aperiodic gap.

In some embodiments, sending, by the terminal, the second message to the target cell within the duration of the aperiodic gap includes: determining, by the terminal, that the duration to receive the first message reaches the waiting duration, where the waiting duration is determined according to the capability information of the terminal; and sending, by the terminal, the second message to the target cell within the duration of the aperiodic gap.

In some embodiments, the capability information indicates the frequency band range currently used by the terminal, and the frequency band range includes the low frequency band range and the high frequency band range.

In some embodiments, the waiting duration is determined by: determining that the capability information of the terminal indicates the low frequency band range; and determining that the waiting duration is the first specified duration.

In some embodiments, the waiting duration is determined by: determining that the capability information of the terminal indicates the high frequency band range; and determining that the waiting duration is the second specified duration.

In some embodiments, the second message is the RACH request based on the PDCCH.

In some embodiments, the first message is the DCI.

Regarding the device in the above embodiments, a specific manner in which each module performs operations has been described in detail in the relevant embodiments of the method, and is not described in detail here.

FIG. 14 is a block diagram of a communication device 3000 according to an example. The communication device 3000 may be the terminal in the communication system shown in FIG. 1 or the network device in the communication system shown in FIG. 1.

Referring to FIG. 14, the communication device 3000 may include one or more of: a processing component 3002, a memory 3004, and a communication component 3006.

The processing component 3002 may be configured to control overall operations of the communication device 3000, such as operations associated with display, telephone calls, data communications, camera operations, and recording operations. The processing component 3002 may include one or more processors 3020 to execute instructions to perform all or part of the steps of the method for determining the timing advance described above. Additionally, the processing component 3002 may include one or more modules to facilitate interaction between the processing component 3002 and other components. For example, the processing component 3002 may include a multimedia module to facilitate interaction between the multimedia component and the processing component 3002.

The memory 3004 is configured to store various types of data to support operation on the communication device 3000. Examples of these data include instructions for any application or method operating on the communication device 3000, contact data, phonebook data, messages, pictures, video, and the like. The memory 3004 may be implemented by any volatile or non-volatile storage device, or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The communication component 3006 is configured to facilitate wired or wireless communication between the communication device 3000 and other devices. The communication device 3000 may access a wireless network based on a communication standard, such as Wi-Fi, 2G, 3G, 4G, 5G, 6G, NB-IoT, eMTC, or the like, or a combination of them. In an example, the communication component 3006 receives a broadcast signal or broadcast-related information from an external broadcast management system via a broadcast channel. In an example, the communication component 3006 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the communication device 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the method for determining the timing advance described above.

The communication device 3000 may be a stand-alone electronic device or may be part of a stand-alone electronic device, for example, in one embodiment, the electronic device may be an integrated circuit (IC) or a chip, where the integrated circuit may be one IC or a collection of a plurality of ICs; the chip may include, but is not limited to: graphics processing unit (GPU), central processing unit (CPU), (field programmable gate array (FPGA), digital signal processor (DSP), application specific integrated circuit (ASIC), system on chip (SOC), etc. The integrated circuit or chip described above may be configured to execute executable instructions (or codes) to implement the method for determining the timing advance described above. The executable instructions may be stored in the integrated circuit or chip or obtained from other apparatuses or devices. For example, the integrated circuit or chip includes a processor, a memory, and an interface for communicating with other devices. The executable instructions may be stored in the memory. The executable instructions, when executed by the processor, implement the method for determining the timing advance described above; or, the integrated circuit or chip may receive executable instructions via the interface and transmit the executable instructions to the processor for execution to implement the method for determining the timing advance described above.

In an example, the present disclosure further provides a non-transitory computer-readable storage medium storing computer program instructions, the computer program instructions, when executed by a processor, implement the steps of the method for determining the timing advance provided by the present disclosure. For example, the computer-readable storage medium may be a non-transitory computer-readable storage medium including instructions. It may be, for example, the memory 3004 described above, including instructions, and the instructions may be executed by the processor 3020 of the communication device 3000 to perform the method for determining the timing advance described above. For example, the non-transitory computer-readable storage medium may be a ROM, a random access memory (RAM), a CD-ROM, a magnetic tape, a floppy disk, an optical data storage device, or the like.

As used herein, the term processor may refer to one processor that performs the defined functions or a plurality of processors that collectively perform defined functions, such that the execution of the individual defined functions may be divided amongst such processors.

In another example, a computer program product is also provided. The computer program product includes a computer program that can be executed by a programmable device, and the computer program has a code segment for performing the method for determining the timing advance described above when executed by the programmable device.

Other embodiments of the present disclosure will readily occur to those skilled in the art after considering the specification and practicing the present disclosure. The present disclosure is intended to cover any variations, uses, or adaptive changes of the present disclosure that follow the general principles of the present disclosure and include the common general knowledge or the conventional technical means in the art which is not disclosed in the present disclosure. The specification and embodiments are considered as examples only, and the true scope and spirit of the present disclosure are indicated by the following claims.

It should be understood that the present disclosure is not limited to the precise structures that have been described above and illustrated in the accompanying drawings, and that various modifications and changes may be made without departing from the scope of the present disclosure. The scope of the present disclosure is limited only by the appended claims.

1. A method for determining a timing advance, performed by a terminal, the method comprising:
receiving a first message sent by a serving cell, wherein the first message is configured to indicate a duration of an aperiodic gap, and the duration of the aperiodic gap is a time for the terminal to determine a timing advance (TA) for a target cell.

2. The method according to claim 1, further comprising:
sending a second message to the target cell within the duration of the aperiodic gap, wherein the second message is configured to determine the TA for the target cell, and there is no service transmission between the terminal and the serving cell within the duration of the aperiodic gap.

3. The method according to claim 2, wherein the second message is not configured with a time of a random access response (RAR) window, and the duration of the aperiodic gap is determined by:
determining the duration of the aperiodic gap according to a first duration and a second duration, wherein the first duration is a duration of a time period configured for the terminal to send a preamble of the second message, and the second duration is a radio frequency (RF) adjustment duration used by the terminal to switch an operating frequency point.

4. The method according to claim 2, wherein the second message is configured with a time of an RAR window, and the duration of the aperiodic gap is determined by:
determining the duration of the aperiodic gap according to a first duration, a second duration and a third duration, wherein the first duration is a duration of a time period configured for the terminal to send a preamble of the second message, the second duration is an RF adjustment duration used by the terminal to switch an operating frequency point, and the third duration is the time of the RAR window for the target cell.

5. The method according to claim 4, wherein determining the duration of the aperiodic gap according to the first duration, the second duration, and the third duration comprises:
determining a sum of the first duration, the second duration, and the third duration as the duration of the aperiodic gap.

6. The method according to claim 2, further comprising:
determining a waiting duration according to capability information of the terminal, wherein sending the second message to the target cell within the duration of the aperiodic gap comprises:
determining that a duration to receive the first message reaches the waiting duration; and
sending the second message to the target cell within the duration of the aperiodic gap.

7. The method according to claim 6, wherein the capability information indicates a frequency band range currently used by the terminal, and the frequency band range comprises a low frequency band range and a high frequency band range.

8. The method according to claim 7, wherein determining the waiting duration according to the capability information of the terminal comprises:
determining that the capability information of the terminal indicates the low frequency band range; and
determining that the waiting duration is a first specified duration.

9. The method according to claim 7, wherein determining the waiting duration according to the capability information of the terminal comprises:
determining that the capability information of the terminal indicates the high frequency band range; and
determining that the waiting duration is a second specified duration.

10. The method according to claim 2, wherein the second message is a random access channel (RACH) request based on a physical downlink control channel (PDCCH).

11. The method according to claim 1, wherein the first message is downlink control information (DCI).

12. A method for determining a timing advance, performed by a network device, the method comprising:
sending a first message to a terminal, wherein the first message is configured to indicate a duration of an aperiodic gap, and the duration of the aperiodic gap is a time for the terminal to determine a timing advance (TA) for a target cell.

13. The method according to claim 12, wherein the first message is configured for the terminal to send a second message to the target cell within the duration of the aperiodic gap, wherein the second message is configured to determine the TA for the target cell, and there is no service transmission between the terminal and a serving cell within the duration of the aperiodic gap.

14. The method according to claim 13, wherein the second message is not configured with a time of a random access response (RAR) window, and sending the first message to the terminal comprises:
determining the duration of the aperiodic gap in the first message according to a first duration and a second duration, wherein the first duration is a duration of a time period configured for the terminal to send a preamble of the second message, and the second duration is a radio frequency (RF) adjustment duration used by the terminal to switch an operating frequency point; and
sending the first message to the terminal; or
wherein the second message is configured with the time of the RAR window, and sending the first message to the terminal comprises:
determining the duration of the aperiodic gap in the first message according to the first duration, the second duration and a third duration, wherein the first duration is the duration of the time period configured for the terminal to send the preamble of the second message, the second duration is the RF adjustment duration used by the terminal to switch the operating frequency point, and the third duration is the time of the RAR window for the target cell; and
sending the first message to the terminal.

15. (canceled)

16. The method according to claim 14, wherein determining the duration of the aperiodic gap in the first message according to the first duration, the second duration, and the third duration comprises:
determining a sum of the first duration, the second duration, and the third duration as the duration of the aperiodic gap.

17. The method according to claim 13, wherein sending, by the terminal, the second message to the target cell within the duration of the aperiodic gap comprises:
determining, by the terminal, that a duration to receive the first message reaches a waiting duration, wherein the waiting duration is determined according to capability information of the terminal; and
sending, by the terminal, the second message to the target cell within the duration of the aperiodic gap.

18. The method according to claim 17, wherein the capability information indicates a frequency band range currently used by the terminal, and the frequency band range comprises a low frequency band range and a high frequency band range.

19. The method according to claim 18, wherein the waiting duration is determined by:
determining that the capability information of the terminal indicates the low frequency band range; and
determining that the waiting duration is a first specified duration; or
wherein the waiting duration is determined by:
determining that the capability information of the terminal indicates the high frequency band range; and
determining that the waiting duration is a second specified duration.

20-24. (canceled)

25. A communication device, comprising:
one or more processors; and
a memory configured to store processor-executable instructions, wherein
the processor-executable instructions, when collectively executed by the one or more processors, cause the communication device to receive a first message sent by a serving cell, wherein the first message is configured to indicate a duration of an aperiodic gap, and the duration of the aperiodic gap is a time for a terminal to determine a timing advance (TA) for a target cell.

26-27. (canceled)

28. A communication device, comprising:
one or more processors; and
a memory configured to store processor-executable instructions, wherein
the processor-executable instructions, when collectively executed by the one or more processors, cause the communication device to perform the method according to claim 12.
